(19) United States
(12) Patent Application Publication
(10) Pub. No.: US 2010/0147768 A1
(43) Pub. Date: Jun. 17, 2010

(54) RENEWABLE SORBENT MATERIAL AND METHOD OF USE

(75) Inventors: Raymond Shane Addleman, Richland, WA (US); John T. Bays, Richland, WA (US); Timothy G. Carter, Eugene, OR (US); Sean A. Fontenot, Eugene, OR (US); Glen E. Fryxell, Kennewick, WA (US); Darren W. Johnson, Eugene, OR (US)

Correspondence Address: KLARQUIST SPARKMAN, LLP, 121 SW SALMON STREET, SUITE 1600, PORTLAND, OR, 97204, US

(73) Assignees: State of Oregon Acting by and through the State Board of Higher Education on Behalf of University; and Battelle Memorial Institute

(21) Appl. No.: 12/632,685

(22) Filed: Dec. 7, 2009

Related U.S. Application Data
(60) Provisional application No. 61/120,321, filed on Dec. 5, 2008.

(51) Int. Cl. B01D 15/04; B01J 49/00

(52) U.S. Cl. 210/670; 210/679

(57) ABSTRACT

Sorbent materials include a support, a base material comprising a first compound covalently bound to the support, and an active material reversibly bound to the base material, wherein the active material comprises a second compound with at least one functional group selected for binding a target species. The active material with the bound target species can be removed by washing the sorbent material with a solvent in which the second compound is soluble. The sorbent material can be regenerated by reversibly binding one or more second compounds having a selected functional group to the washed base material.

### CROSS REFERENCE TO RELATED APPLICATION

This application claims the benefit of U.S. Provisional Patent Application No. 61/120,321, filed Dec. 5, 2008, which is incorporated herein by reference.

### ACKNOWLEDGMENT OF GOVERNMENT SUPPORT

This invention was made with government support under Career Grant No. CHE-0545206 awarded by the National Science Foundation and Grant No. 1R21ES015620-01A1 awarded by the National Institute of Environmental Health & Science. The government has certain rights in the invention.

### FIELD

The disclosure pertains to materials for reversibly sorbing target species.

### BACKGROUND

Access to sustainable, clean drinking water is an increasing concern as the Earth's human population continues its steady growth. Degrading water quality in both industrialized and nonindustrialized nations has the potential to cause great economic strain on the world's governing bodies. At the same time, this offers a challenge to researchers to discover new, functional, designer materials that have high uptake capacities and selectivity for environmental contaminants. The need to develop inexpensive and efficient filtration media is a high priority.

### SUMMARY

Embodiments of renewable sorbent materials are disclosed. The sorbent materials include a support, a base material comprising a first compound that is typically covalently bound or otherwise substantially bound to the support, and an active material reversibly bound to the base material, wherein the active material comprises a second compound with at least one functional group R. In some embodiments, the support is a mesoporous support, particularly a silica-based mesoporous support, or a nanoparticle. In some embodiments, the first compound is an aromatic compound. In certain embodiments, the first compound is an organosilane comprising a phenyl, nitrophenyl, thiophene, pentafluorophenyl group, or other aryl group (such as naphthyl, anthracenyl, hydroxypyridinoate).

In other examples, the functional group R of the second compound is capable of binding to a target species. In some embodiments, the target species are metals, metalloids, oxyanions, radioactive species, polar organics, and combinations thereof. In particular embodiments, R is —SH, —N(CH₂CO₂H)₂, —OH, —NHCONH₂, —NHCSNH₂, —SO₂NH₂, or —NHCOCH₂P(═O)R′R″) wherein R′ and R″ are lower alkyl groups. In some embodiments, the second compound includes a plurality of functional groups for binding to one or more target species. In certain embodiments, the target species is a metal cation, such as a heavy metal cation (e.g., arsenic, selenium, cobalt, silver, cadmium, mercury, thallium or lead), and the sorbent material has a high affinity (e.g., a distribution coefficient of at least 1×10⁴) for the target species. In some embodiments, the second compound is an aromatic compound.

In representative embodiments, the second compound includes a plurality of functional groups R wherein each of the functional groups is independently —SH, —N(CH₂CO₂H)₂, —OH, —NHCONH₂, —NHCSNH₂, SO₂NH₂, or —NHCOCH₂P(═O)R′R″) wherein R′ and R″ are lower alkyl groups. In certain embodiments, the active material comprises a plurality of second compounds, each second compound having at least one functional group R. In other alternatives, the second compound comprises a linker Y covalently attached to an aromatic ring, and at least one functional group R covalently attached to the linker Y. In particular embodiments, the linker Y is a methyl or ethyl group.

Methods for making a sorbent material include covalently binding a base material comprising a first compound to a support. An active material comprising a second compound that includes at least one functional group is bound to the base material. In some embodiments, the mesoporous support is silica-based, and the first compound is an aromatic organosilane. In some embodiments, the second compound is an aromatic compound.

Methods include exposing a sorbent material to a solution having an initial concentration of a target species. The sorbent material typically includes a support, a base material of a first compound covalently bound to the support, and an active material of one or more second compounds reversibly bound to the base material, wherein each second compound has at least one functional group R. The functional group R is capable of binding the target species, and exposing the solution to the sorbent material is effective to bind at least a portion of the target species to the functional group R, producing a stripped solution having a final concentration of the target species that is decreased relative to a concentration in the absence of the sorbent material. In certain embodiments, less than 10% of the active material dissociates from the base material when the sorbent material is exposed to the solution. In other examples, a final concentration of the target species is decreased at least 50% relative to the initial concentration.

In some representative examples, after exposing the solution to the sorbent material, the active material and bound target species are removed from the sorbent material by rinsing the sorbent material with a solvent in which the second compound is soluble. In particular embodiments, the sorbent material is regenerated by reversibly binding an action material that isolates one or more second compounds to the base material of the washed sorbent material, each second compound including at least one functional group that can be the same as or different from the functional group R.

Embodiments of the disclosed sorbent material have a surface chemistry that can be installed upon complex support materials and easily removed. Such a capability allows expensive supports to be reused, the surface chemistry to be changed between events, the surface chemistry to be refreshed and prevent fouling, and the captured material to be eluted in very small volume leaving the vast majority of the structure behind. Such a capability has utility not only to environmental and industrial separations but also to analytical collection and measurement. The ability to collect an analyte on a sorbent and then selectively elute only the thin surface layer provides tremendous capability for preconcentration and sample clean-up.

The foregoing and other features, and advantages of the invention will become more apparent from the following detailed description, which proceeds with reference to the accompanying figures.

### BRIEF DESCRIPTION OF THE DRAWINGS

FIG. 1 is a schematic illustration of one embodiment of the disclosed materials.

FIG. 2 is a schematic illustration of another embodiment of the disclosed materials.

FIG. 3 is an illustration of one embodiment of a base material bound to a support.

FIG. 4 is a flowchart of one embodiment of a method for making and using the disclosed materials.

FIG. 5 is a graph of weight percent versus temperature for thermogravimetric analyses of 1,4-bis(mercaptomethyl)benzene reversibly bound to phenyl-functionalized MCM-41 or physisorbed on native MCM-41 silica.

FIG. 6 is a series of IR spectra of some representative materials.

FIG. 7 is a bar graph showing log K_{d} values for binding of metal ions to thiol-SAMMS materials.

FIG. 8 is a bar graph showing log K_{d} values for binding of metal ions to 1,3- and 1,4-bis(mercaptomethyl)benzene bound to phenyl-SAMMS materials.

FIGS. 9A-C depict various arrangements of 1,3- and 1,4-bis(mercaptomethyl)benzene reversibly bound to a phenyl monolayer.

FIG. 10 is a bar graph showing loading and percent leaching for representative embodiments of the disclosed materials.

FIG. 11 is a bar graph showing loading, percent leaching, and affinity for representative embodiments of the disclosed materials.

### DETAILED DESCRIPTION

Embodiments of materials capable of filtering a fluid and sorbing target species from the fluid are disclosed. The sorbent materials feature functionalized ligands reversibly bound to a functionalized support via non-covalent interactions. Target species include, without limitation, toxic substances such as heavy metals, metalloids, oxyanions, radioactive species, other cations, polar organic compounds, and mixtures thereof. Embodiments of methods for making and using the sorbent materials also are disclosed.

### I. TERMS AND DEFINITIONS

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

Definitions of common terms in chemistry may be found in Richard J. Lewis, Sr. (ed.), Hawley's Condensed Chemical Dictionary, published by John Wiley & Sons, Inc., 1997 (ISBN 0-471-29205-2).

In order to facilitate review of the various embodiments of the disclosure, the following explanations of specific terms are provided:

Absorption is the incorporation of a substance in one state into another of a different state, e.g., a liquid absorbed by a solid, or a gas absorbed by a liquid.

Adsorption is the physical adherence or bonding of ions and molecules onto the surface of another molecule. An ion or molecule that adsorbs is referred to as an adsorbate. Adsorption can be characterized as chemisorption or physisorption, depending on the character and strength of the bond between the adsorbate and the substrate surface.

The term aliphatic means having a branched or unbranched carbon chain. The chain may be saturated (having all single bonds) or unsaturated (having one or more double or triple bonds).

Alkyl refers to a hydrocarbon group having a saturated carbon chain. The chain may be branched or unbranched. The term lower alkyl means the chain includes 1-10 carbon atoms.

Amorphous means non-crystalline, having no or substantially no molecular lattice structure. Liquids are generally amorphous. Some solids or semisolids, such as glasses, rubber, and some polymers, are also amorphous. Amorphous solids and semisolids lack a definite crystalline structure and a well-defined melting point.

Arenes are hydrocarbon aromatic rings based on benzene (C₆H₆).

Aromatic or aryl compounds typically are unsaturated, cyclic hydrocarbons having alternate single and double bonds. Benzene, a 6-carbon ring containing three double bonds, is a typical aromatic compound.

Chemisorption is a type of adsorption characterized by a relatively strong interaction between an adsorbate and a substrate. These interactions can be comparable in strength to ionic and covalent bonds and are much stronger than the van der Waals interactions that are characteristic of physisorption. However, the strength of the interaction between a chemisorbed adsorbate and its substrate can be environment dependent. For example, a nonpolar adsorbate may be strongly adsorbed to a nonpolar substrate in the presence of a polar or aqueous solvent. In the presence of a nonpolar solvent, the interaction may be weakened and the chemisorbed adsorbate may dissociate from the substrate and dissolve in the solvent.

CMPO refers to a carbamoylmethylphosphine oxide compound. CMPO has the general structure:

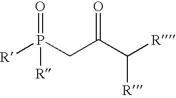

where R′ and R″ are independently a substituted or unsubstituted alkyl, aryl, or heteroaryl group. R′″ and R″″ are independently hydrogen, or a substituted or unsubstituted aryl or heteroaryl group. In some embodiments, R′ and R″ are independently lower alkyl groups or aryl groups (e.g., octyl, phenyl), R′″ is hydrogen, and R″″ is a substituted or unsubstituted aryl or heteroaryl group (e.g., phenyl, naphthyl, anthracenyl).

Conjugating, joining, bonding or linking: Coupling a first unit to a second unit. This includes, but is not limited to, covalently bonding one molecule to another molecule, noncovalently bonding one molecule to another (e.g. electrostatically bonding), non-covalently bonding one molecule to another molecule by hydrogen bonding, non-covalently bonding one molecule to another molecule by van der Waals forces, and any and all combinations of such couplings.

A functional group is a specific group of atoms within a molecule that is responsible for the characteristic chemical reactions of the molecule. Exemplary functional groups include, without limitation, alkane, alkene, alkyne, arene, halo (fluoro, chloro, bromo, iodo), epoxide, hydroxyl, carbonyl (ketone), aldehyde, carbonate ester, carboxylate, ether, ester, peroxy, hydroperoxy, carboxamide, amine (primary, secondary, tertiary), ammonium, imide, azide, cyanate, isocyanate, thiocyanate, nitrate, nitrite, nitrile, nitroalkane, nitroso, pyridyl, phosphate, sulfonyl, sulfide, thiol (sulfhydryl), disulfide.

The term “heavy metal” typically refers to a metal with a high atomic weight. Heavy metals can be defined as metals having an atomic weight greater than that of sodium, an atomic number greater than 20, or a density greater than 4.0 g/cm³ to 7.0 g/cm³. As commonly used, the term “heavy metals” refers to transition metals and main group metalloids that are toxic to living organisms, e.g., lead, mercury, nickel, cadmium, chromium, arsenic, tin, silver, etc.

Heteroaryl compounds are aromatic compounds having at least one heteroatom, i.e., one or more carbon atoms in the ring has been replaced with an atom having at least one lone pair of electrons, typically nitrogen, oxygen, or sulfur.

HOPO refers to hydroxypyridinoate. As used herein, HOPO typically refers to a 1,2-HOPO compound with the structure:

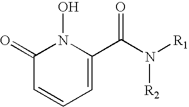

where R₁ is hydrogen or an alkyl group, particularly a lower alkyl group (e.g., methyl, ethyl, etc.), and R₂ is an alkyl group.

Physisorption is a form of adsorption characterized by weak bonding between an adsorbate and a substrate. The weak bond is due to van der Waals forces, i.e., an induced dipole moment between the adsorbate and the substrate. There is no change in the electronic structure of the adsorbate. Accordingly, a physisorbed adsorbate can be removed from a substrate at low temperatures with relatively non-stringent conditions.

A polar compound is one in which electrons are not equally shared between the atoms i.e., areas of positive and negative charges are permanently separated. A common example is water. Other polar compounds typically are soluble in water. In contrast, a nonpolar compound is one in which electrons are equally, or nearly equally, shared between the atoms. Common examples include fats and oils. Nonpolar compounds typically are insoluble in water. Polar and nonpolar compounds are sometimes characterized by the dipole moment, which is a measure of the net polarity of the compound. A compound with a dipole moment of zero is nonpolar. Polar molecules have a dipole moment greater than zero. The greater the dipole moment, the greater the polarity of a molecule.

Pore: One of many openings or void spaces in a solid substance of any kind. Pores are characterized by their diameters. According to IUPAC notation, micropores are small pores with diameters less than 2 nm. Mesopores are mid-sized pores with diameters from 2 nm to 50 nm. Macropores are large pores with diameters greater than 50 nm.

Porosity: A measure of the void spaces or openings in a material. Porosity is measured as a fraction, between 0-1, or as a percentage between 0-100%.

Porous: A term used to describe a matrix or material that is permeable to fluids (such as liquids or gases). For example, a porous matrix is a matrix that is permeated by a network of pores (voids) that may be filled with a fluid. In some examples, both the matrix and the pore network (also known as the pore space) are continuous, so as to form two interpenetrating continua. Many materials such as cements, foams, metals and ceramics can be prepared as porous media.

Sorption refers to absorption and/or adsorption. For example, a liquid may be absorbed by a solid substrate and molecules within the liquid may physically adhere to the substrate molecules via chemisorption or physisorption.

### II. RENEWABLE SORBENT MATERIALS

Disclosed herein are representative renewable sorbent materials. As used herein, renewable means that an active material with bound target species can be removed from the sorbent material, a new layer of active material can be applied to the sorbent material, and the sorbent material can be used again.

A sorbent material can be prepared by forming self-assembled monolayers on a support. In some embodiments, the support is a mesoporous support (SAMMS™ materials) such as described in Feng and Fryxell, U.S. Pat. No. 6,326,326, which is incorporated herein by reference. Other supports include metals, polymers, metal oxides and nanoparticles (e.g., metal, metal oxide, or semiconductor nanoparticles). The self-assembled monolayers can include functional groups suitable for sorbing various atoms, ions, or molecules. As a fluid (e.g., contaminated water) passes over and/or through the mesoporous support, target species are bound or sorbed by the functional groups. The surfaces, including the surfaces within the pores, of the mesoporous support are functionalized to bind desired species.

For example, a variety of commercially available and synthetically accessible functionalized organosilanes can be affixed inside the pores of a mesoporous support as self-assembled monolayers. The result is a dense population of chelating sites which can achieve exceptionally high uptake levels of target species. A disadvantage to such SAMMS™ materials is the relatively stringent conditions, e.g., acid stripping, used to remove the functionalized organosilanes and bound target species so that the mesoporous support can be coated with a fresh material of functionalized organosilanes and reused for sorbing target species.

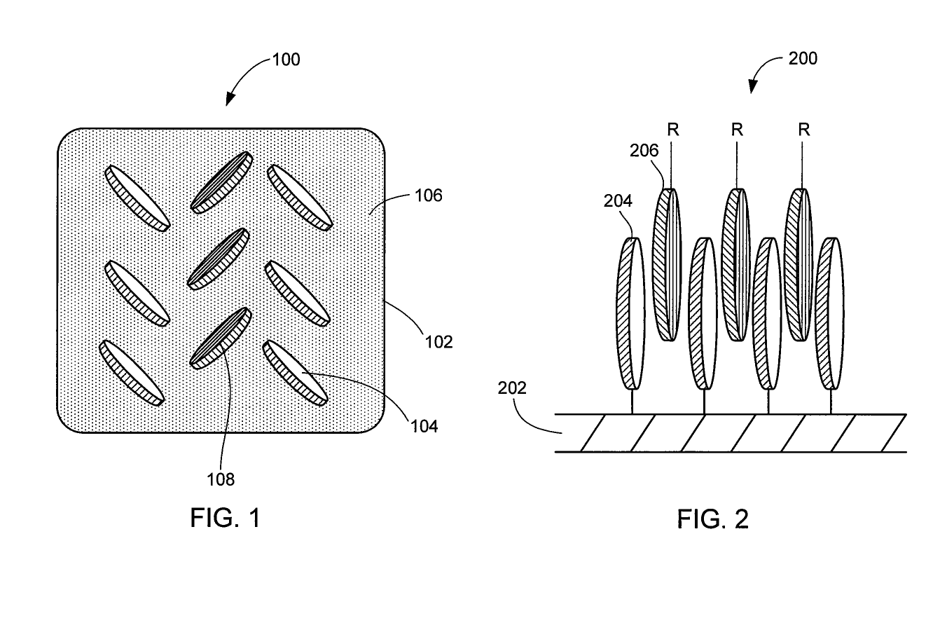

Disclosed embodiments of the novel renewable sorbent material enable removal of bound target species without such stringent conditions. In a representative example shown in FIG. 1, a renewable sorbent material 100 includes a mesoporous support 102, a base material 104 comprising a first compound covalently attached to a surface 106 of the mesoporous support 102 (including surfaces within the pores), and an active material 108 comprising a second compound reversibly bound (e.g., chemisorbed) to the base material 104. The second compound includes one or more functional groups capable of sorbing or binding one or more target species.

The base material 104 can be provided as a layer or a coating on the surface 106, and typically is configured to as to at least partially coat, cover, or bind to at least a portion of the surface 102, including portions of surfaces of any pores, depressions, recesses, protrusions, or regular or irregular features on or in the surface 102. In addition, the active material 108 is generally configured so as to couple to at least some portions of the base material, and can form an active layer or coating that at least partially covers the surface 106 to which the base material 104 is secured. The active material 108 generally is secured to or binds to the base material 104, but in some examples, portions of the active material bind to the surface 106 as well.

In the representative example of FIG. 1, molecules of the first compound and the second compound are arranged in a herringbone pattern with respect to the mesoporous support 102.

FIG. 2 illustrates another representative sorbent material 200 in which a base material 204 and an active material 206 are positioned in an offset orientation at the mesoporous support 202. Molecules of the active material 206 include at least one functional group R capable of binding one or more target species. In typical examples, the base material and the active material are aromatic compounds.

### Representative Support Materials

The support materials are typically solid materials that can be functionalized by covalently attaching a base material, such as an aromatic compound. Suitable support materials include metals, polymers, metal oxides (e.g., silica, alumina, or titania), and nanoparticles (e.g., metal, metal oxide, or semiconductor nanoparticles, such as iron, gold, iron oxide, CdSe, etc.). Typically support materials are mesoporous with sufficient strength, porosity, and chemical resistance to be suitable for filtering a fluid and sorbing target species from the fluid.

In certain embodiments, the mesoporous support is a silica-based support. One example of a silica-based mesoporous support material is a molecular sieve with a honeycomb-like porosity, referred to as MCM-41. MCM-41 has hexagonal pores forming channels that can have diameters from 1.5 nm to 20 nm. MCM-41 typically has approximately 80% porosity with typical surface areas from 500 m²g⁻¹ to more than 1000 m²g⁻¹. MCM-41 channel walls are amorphous SiO₂. MCM-41 has sufficient structural integrity and chemical resistivity to be suitable for use as a sorbent support material.

### Representative Base Materials

Base materials comprising aromatic or other compounds are secured to a surface of the support material. Suitable compounds for the base material include aliphatic or substituted aliphatic compounds (e.g., C3-C22 hydrocarbons), cycloaliphatic or substituted cycloaliphatic compounds (e.g., cyclohexyl compounds), phenyl or substituted phenyl compounds (e.g., nitrophenyl, pentafluorophenyl), heterocyclic aromatic groups (e.g., thiophene, hydroxypyridinoate), extended aromatic groups (e.g., naphthalene), and other electron-rich or electron-deficient conjugated systems. Such compounds can be attached to the support by any suitable means. Typically the base material compound includes a functional group or groups suitable for attaching the molecule to a support surface. For example, an organophosphate compound can be covalently attached to a titania support. In some embodiments, the mesoporous support is a silica-based material and the base material compound is an aromatic organosilane. In such embodiments, the aromatic compound is bound to the silica surface by the silane moiety. In other embodiments, the mesoporous support is an alumina- or titania-based material, and the compound is an organocarboxylate or organophosphate, respectively.

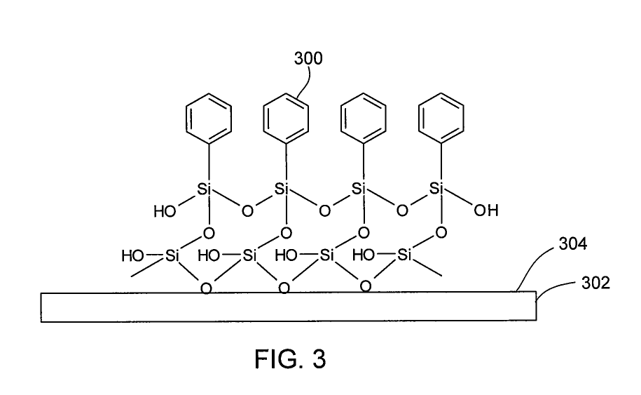

FIG. 3 illustrates one embodiment of a phenylsilane base material 300 on a silica mesoporous support 302. The phenyl molecules are held in a substantially upright position perpendicular to a surface 304 of the mesoporous support 306. As shown in FIG. 3, the base material forms a monolayer with vertical aromatic rings and is well-suited, both sterically and electronically, for coupling to a variety of active layers, such as other functionalized arenes. This approach enables the renewable sorbent material to be customized by varying the compounds selected to form the active material. Additionally, the density, e.g., the number of molecules per unit area, of the base material can be varied. The base material need not completely cover the support surface, and in some cases the base material on the support surface is thicker than a mono-layer.

Representative Active Materials

Layers or coatings of active materials can be formed by reversibly (i.e., non-covalently) binding a second compound to the base material. In typical examples, the active material is selected so as to be soluble in a polar or nonpolar solvent depending on the fluid to be filtered. For example, for water-based filtration, the active material is typically relatively insoluble or less soluble in polar solvents such as water than in nonpolar solvents. For reversible binding of the active material to a base material, the active material is selected to have solubility characteristics that are similar to those of the base material. For example, if the base material is a nonpolar compound (e.g., a phenyl compound), the active material is generally a nonpolar or relatively nonpolar compound. In other examples, both the base material and the active material can be polar compounds, particularly for applications in which the fluid to be filtered is nonpolar.

Suitable active materials include substituted aliphatic compounds (e.g., C3-C22 hydrocarbons), substituted cycloaliphatic compounds (e.g., cyclohexyl compounds), substituted phenyl compounds, substituted heterocyclic aromatic groups, and substituted extended aromatic groups, among others. In some embodiments, the base material and active material are both aromatic compounds.

The active material includes a functional group capable of binding one or more target species. In some embodiments, the active material is an aromatic compound with the general structure Ar—R, wherein Ar represents an aryl or heteroaryl group, such as a phenyl group, a heterocyclic aromatic group (e.g., pyridine, pyridinone, thiophene), an extended aromatic group (e.g., naphthalene), or an electron-rich or electron-deficient conjugated system. R represents a functional group capable of binding one or more desired target species, such as toxic metals, metalloids, oxyanions, radioactive species, and/or polar organics. Suitable functional groups include hydroxyl, thiol, carboxyl, ketone, thione, aldehyde, amine, amide (including substituted amide, e.g., carbamide, sulfonamide), imide, imine (particularly phosphate-based imine, e.g., phosphinimine), phosphines, and phosphine oxides. For example, functionalized aromatic compounds with utility for sorbing metals include, but are not limited to, ureas, thioureas, phosphinimines, hydroxypyridinoate (HOPO), sulfocatecholamide (CAMS), terephthalimide, carbamoylmethylphosphine oxide (CMPO), phosphine derivatives, phosphine oxide derivatives, sulfonamide derivatives, and ethylenediaminetetraacetic acid (EDTA) derivatives. Functionalized aromatic compounds with utility for sorbing anions include oxygen-based ligands, such as dihydroxybenzenes (e.g., catechol), and N-phenyliminodiacetic acid. Thus, the renewable sorbent material can be functionalized based upon the identity and/or characteristics of the desired target species.

In some embodiments, the functionalized aromatic molecules may include a plurality of functional groups R₁, R₂, R₃. For example, each aromatic molecule may include 1, 2, or 3 functional groups as shown in the structures below

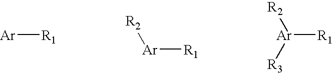

wherein Ar represents an aryl or heteroaryl group and R₁, R₂, and R₃ represent functional groups. As shown below with respect to a phenyl group, R₁, R₂, and R₃ may be positioned anywhere on the aromatic ring.

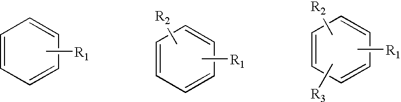

R₁, R₂, and R₃ may be the same or may be different from one another. In some embodiments, R₁, R₂, and R₃ are independently selected from —SH, —N(CH₂CO₂H)₂, —OH, —NHCONH₂, —NHCSNH₂, SO₂NH₂, —P((═O)R′R″), —NHCOCH₂P((═O)R′R″) wherein R′ and R″ are independently lower alkyl or aryl groups.

In certain embodiments, at least one functional group R is a thiol (—SH) group, and the aromatic molecules can sorb metal ions such as Hg²⁺, Pb²⁺, Cd²⁺, and Ag⁺. Exemplary thiol-functionalized aromatic molecules are shown in Table 1. Sorbent materials including such thiol-functionalized molecules can be used for heavy metal uptake from water.

TABLE 1

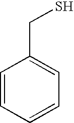

benzylmercaptan

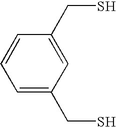

1,3-bis(mercaptomethyl)benzene

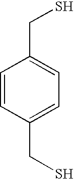

1,4-bis(mercaptomethyl)benzene

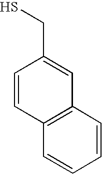

2-mercaptomethyl naphthalene,
or naphthalen-2-ylmethanethiol

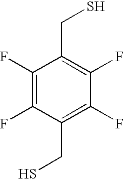

1,4-bis(mercaptomethyl)tetrafluorobenzene

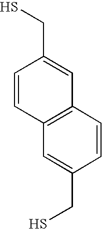

2,6-bis(mercaptomethyl)naphthalene or
[6-(sulfanylmethyl)naphthalen-
2-yl]methanethiol

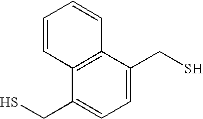

1,4-bis(mercaptomethyl)naphthalene or
[4-(sulfanylmethyl)naphthalen-
1-yl]methanethiol

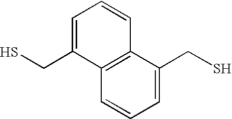

1,5-bis(mercaptomethyl)naphthalene or
[5-(sulfanylmethyl)naphthalen-
1-yl]methanethiol

In other embodiments, the functional group is an imino group. One exemplary imino-functionalized aromatic molecule is N-phenyliminodiacetic acid (2-[N-(carboxymethyl)anilino]acetic acid).

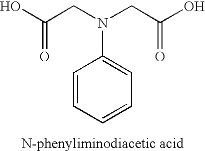

In certain embodiments, an active material is formed of two or more different aromatic molecules with different functional groups. Such embodiments provide the sorbent material with additional versatility, allowing binding to a plurality of target species having different characteristics. For example, the active material may comprise N-phenyliminodiacetic acid and one of the thiol-functionalized molecules shown in Table 1.

In some embodiments, the functional group R is directly bonded to the aryl ring. In other embodiments, R is attached to the aromatic ring Ar via a linker Y. These two bonding arrangements are shown below:

Ar—R or Ar—Y—R

Suitable linkers include aliphatic groups and substituted aliphatic groups. In some embodiments, linker Y is a lower alkyl chain (—CH₂—)ₙ where n is an integer from 1 to 10. In particular embodiments, n is 1, 2, or 3. For example, Y may be a methyl (—CH₂—) or ethyl (—CH₂CH₂—) linker. The length of the linker may be varied based upon the nature and number of functional groups R attached to the aromatic ring, as well as based upon the nature of the target species. For example, it may be advantageous to use a longer linker with a more bulky functional group or target species as longer linkers often have more flexibility and may reduce steric hindrances.

### Regeneration of Sorbent Materials

The arrangement of the base and active materials of the disclosed renewable sorbent materials provides distinct advantages over conventional sorbent materials comprising a single material of a functionalized compound. In some embodiments, the active material includes an aromatic compound that is reversibly bound to one or more molecules of the base material via chemisorption or other binding forces, such as π-stacking. Molecules of the active material are typically at least partially inserted between adjacent molecules of the base material. (See FIG. 2.) In some examples, aromatic active material molecules may be reversibly bound to an aromatic base material by relatively weak π-stacking interactions that occur when an aromatic ring of an active material molecule at least partially inserts between aromatic rings of adjacent base material molecules. In such a configuration, the electrons of both compounds can interact with one another, reversibly binding the active material to the base material. In other examples, the base material comprises a hydrocarbon, e.g., C3-C22, and the active material comprises a hydrocarbon, e.g., C3-C22, with a functional group. The hydrocarbon chain of the active material at least partially inserts between hydrocarbon chains of the base material. In such a configuration, reversible binding is due to hydrophobic interactions between the hydrocarbon chains of the active material and the base material.

As used herein, reversible binding refers to a non-covalent or electrostatic interaction between active material molecules and base material molecules, wherein the strength of the interaction is, at least in part, dependent on the environment. For example, if both the base material and the active material are nonpolar or relatively nonpolar compounds, the interaction is strong when the sorbent material is exposed to a polar environment, such as an aqueous solution, and the active material will remain bound to the base material in such an environment. However, when the sorbent material is exposed to a relatively nonpolar environment, such as a nonpolar organic solvent, the interaction weakens and active material molecules dissociate from the base material.

In some examples, reversible binding is based on relative solubilities in a fluid to be filtered and a fluid used to remove active material after binding to a target species. As noted above, the active material is generally relatively insoluble in the fluid to be filtered, and relatively soluble in a fluid used for removal of the active material after capture of target species. If both the base material and the active material also comprise nonpolar molecules, the active material molecules will be more soluble in the base material than in an aqueous or polar solvent and will remain bound to the base material in a polar solvent. However, if the sorbent material is exposed to a nonpolar solvent in which the active material molecules have a greater solubility, at least a portion of the active material will dissociate from the base material. In other words, the active material will remain preferably bound to the base material when it is more soluble in the base material than in the surrounding solvent or environment. In some examples, both the active material and the base material are polar, typically for filtering nonpolar fluids, and permitting regeneration based on a polar solvent.

In some examples, both the base material and the active material are formed of compounds comprising aromatic rings. When the renewable sorbent material is placed into an aqueous solution (e.g., contaminated water), the aromatic rings of the active material molecules remain strongly bound to, or associated with, the aromatic rings of the base material molecules. The active material can be removed by any suitable means after the target species has been bound. For example, the active material and bound target species may be removed by washing the sorbent material with a nonpolar or relatively nonpolar solvent (e.g., pentane) in which the active material is soluble. The nonpolar solvent effectively weakens the ic-stacking interactions between the active and base materials, allowing active material molecules to dissociate from the base material and become solubilized in the solvent. The base material molecules, however, are covalently bound to the mesoporous support; the mesoporous support and base material remain intact when the sorbent material is washed with the solvent. In some embodiments, the sorbent material is washed with a supercritical fluid (e.g., supercritical CO₂) to remove the active material and bound target species.

Thus, exposing the sorbent material with its bound target species to a suitable solvent removes the active material molecules and the target species bound to the active material molecules, effectively cleaning the sorbent material. A new active material can be deposited onto the base material, regenerating the sorbent material and allowing it to be reused.

### III. REPRESENTATIVE METHODS OF MAKING SORBENT MATERIALS

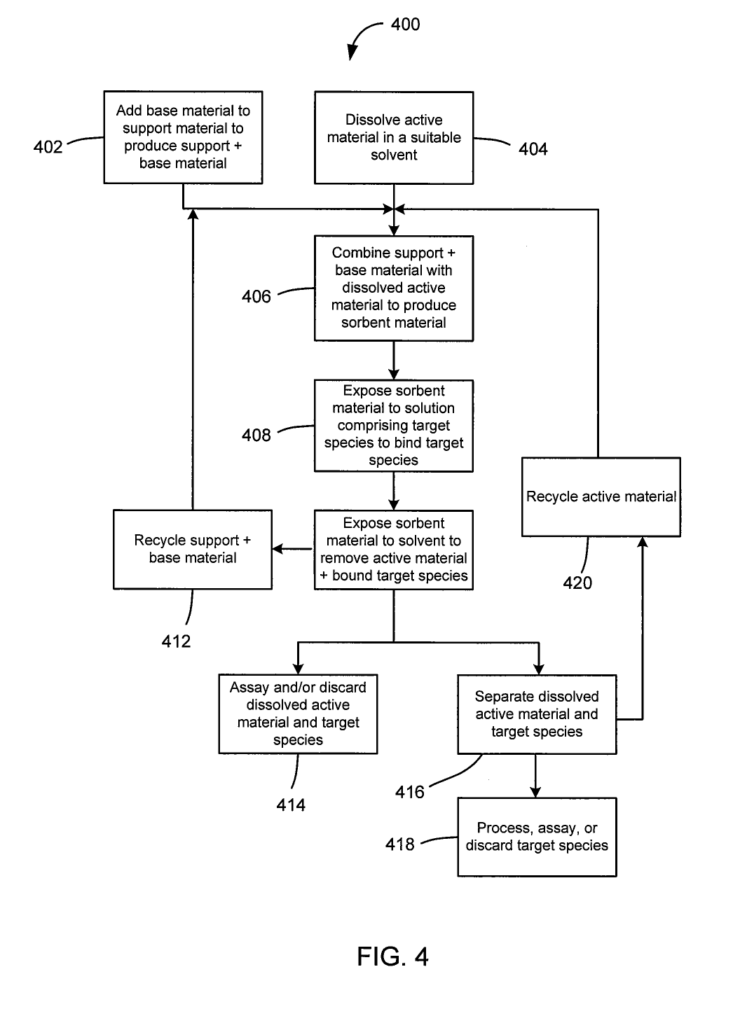

FIG. 4 illustrates one embodiment of a method 400 for making and using a renewable sorbent material. A base material is attached to a support material by any suitable means (step 402). For example, if the support is a silica-based mesoporous support, an organosilane can be used to form a monolayer or partial monolayer of molecules on the mesoporous support surface. With alumina- or titania-based supports, organocarboxylates or organophosphates can be used, respectively, to form the base material.

In some embodiments, a silica mesoporous support is hydrated with a toluene/water mixture. Hydration provides silicon atoms on the surface with a hydroxyl group, producing a surface silanol. Additionally, hydration results in one or more monolayers of water on the silica surface. An organosilane, such as an alkoxy- (e.g., phenyltrimethoxy- or phenyltriethoxysilane) or halosilane (e.g., trichlorophenylsilane), is then added. Hydration of the surface silica facilitates hydrolysis of the alkoxy- or halosilane to a hydroxysilane, which is capable of lateral migration on the silica surface by the breaking and reforming of hydrogen bonds to the surface hydroxyls. Van der Waal's and other weak forces drive aggregation promoting dense monolayer formation on substrates with high organosilane loading. For example, when trichlorophenylsilane is used, surface coverage ranges from 0.01 molecules nm⁻² (sparsely covered surface) to 3.1 molecules nm⁻². Sparsely covered substrates presumably contain island domains rather than complete surface coverage due to the limited organosilane present in the reaction mixture. The hydrogen-bonded organosilane undergoes condensation with a surface silanol, resulting in covalent attachment of the organosilane to the silica surface. Additionally, any remaining halide atoms or alkoxy groups on the organosilane may undergo hydrolysis and condensations, thereby crosslinking the organosilane molecules bound to the silica surface. The covalently bonded organosilane with its aromatic moiety forms the base material, as illustrated in FIG. 3.

An aromatic compound including at least one functional group is chemisorbed onto the base material to form an active material. In some embodiments, a functionalized aromatic compound is dissolved in an organic solvent (e.g., chloroform, dichloromethane, tetrahydrofuran) to form a homogeneous, or substantially homogeneous, solution (FIG. 4, step 404). The mesoporous substrate with its attached base material is added to the solution and allowed to react for a period of time, such as several hours (step 406). Because both the functionalized aromatic compound and the base material are relatively nonpolar, molecules of the functionalized aromatic compound become associated with, or chemisorbed onto, the base material via electrostatic interactions, thereby producing the sorbent material. Without wishing to be bound by any particular theory of operation, it is thought that the aromatic rings of the active material interact with aromatic rings in the base material via face-to-face or edge-to-face interactions between the π electrons, i.e., n-stacking.

### IV. METHODS OF USING SORBENT MATERIALS

Embodiments of the disclosed renewable sorbent material are suitable for binding and removing target species from a solution or a vapor. In some embodiments, the sorbent materials are used to remove an undesired target species from a solution or vapor. For example, the sorbent material may be used to remove heavy metals from contaminated water.

In other embodiments, the disclosed sorbent materials are used for analytical applications. For example, a target analyte can be collected on the sorbent material. The bound analyte and active material are then removed from the sorbent material, producing a highly concentrated, purified target analyte that can be subsequently assayed. If desired, the target analyte and active material are further separated by methods known to one of ordinary skill in the art. Thus, embodiments of the disclosed sorbent materials allow a target analyte to be selectively removed from a solution, concentrated, and purified.

With reference to FIG. 4, a solution containing an initial concentration of a target species is directed to and/or filtered through the sorbent material (step 408). Typically the solution is a polar solution, such as an aqueous solution (e.g., contaminated water). As the solution flows across, or filters through, the sorbent material, target species become bound to the functionalized molecules on the sorbent material's surface, producing a stripped solution having a decreased concentration of target species. In some embodiments, the process removes at least 5%, at least 10%, at least 25%, at least 50%, at least 75%, at least 90%, or up to 100% of the target species from the solution. For example, the process may remove 5-95%, 10-90%, or 25-75% of the target species from the solution.

The renewable sorbent material can also be assessed in terms of its affinity for a target species. Affinity is determined by measuring the concentration of the target species in a solution before and after exposure to the renewable sorbent material, and calculating the distribution coefficient K_{d} which is a measure of ratio of a chemical's sorbed concentration to the dissolved concentration at equilibrium:

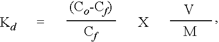

wherein Cₒ is an initial concentration of the target analyte, C_{f} is a final concentration of the target analyte, V is a volume (mL) of the matrix, M is a mass (g) of the sorbent. Disclosed embodiments of the renewable sorbent material have distribution coefficients for heavy metals of at least 5×10², at least 1×10³, at least 1×10⁴, at least 1×10⁵, or at least 1×10⁶. In some embodiments, the renewable sorbent material has a distribution coefficient for a metal cation of up to 1.0×10⁹, such as from 5.0×10² to 2×10³, 1×10³ to 3×10⁴, 1×10⁴ to 7×10⁶, or 1×10⁵ to 7×10⁶, or 1×10⁶ to 1×10⁹.

During use, the active material remains bound to the base material. In some embodiments, less than 40%, less than 30%, less than 10%, less than 5%, or even less than 2% of the active material molecules dissociate from the base material during filtration.

After use, the active material molecules and bound target species are removed from the sorbent material by rinsing the sorbent material with a suitable solvent in which the active material molecules are soluble (step 410). Suitable solvents remove the functionalized active material molecules and bound target species without removing the base material molecules from the mesoporous silica support. When the active material is formed from aromatic molecules, the solvent typically is a nonpolar or relatively nonpolar organic solvent. In some embodiments, the solvent is a substituted or unsubstituted alkane, alcohol, ether, ketone, or aromatic compound that is relatively nonpolar and a liquid at ambient temperature. Preferably the solvent is relatively inexpensive and nontoxic. Suitable solvents may include chloroform, dichloromethane, pentane, hexane, cyclopentane, cyclohexane, and toluene, among others. Exemplary solvents include chloroform and pentane. In certain embodiments, supercritical or near critical fluids such as supercritical CO₂ or supercritical methane, ethane, propane, ethylene, propylene, methanol, ethanol, or acetone may be used.

Removal of the active material and bound target species results in a base material and support that is devoid or substantially devoid of active material molecules, or that has a substantially reduced number or density of active material molecules. The support and base material can then be recycled (step 412). The sorbent material is regenerated by exposure to one or more active materials (step 406) that can be the same as or different from a previously removed active material.

In some embodiments, the active material and target species are then assayed and/or discarded in an appropriate manner (step 414). In other embodiments, the active material and target species are separated by any suitable means (step 416). The separated target species typically is highly concentrated and purified. It may be processed further, assayed, or discarded in an appropriate manner (step 418). The separated active material is recycled and reused to regenerate the sorbent material (step 420).

This ability to refresh or replace the functionalized surface of the sorbent material significantly increases its versatility and reduces the costs associated with sorbent materials that can be used only once before disposal. Because the support and base material are recycled and reused, the quantity of waste is reduced compared to conventional filtration media that are used once and discarded. Additional waste reduction is achieved when the active material is also recycled and reused. Embodiments of the disclosed sorbent materials are capable of multiple purification/regeneration cycles before fouling or degradation of the base material or support occurs.

### V. PROTOCOLS AND WORKING EXAMPLES

### Protocols

### Attachment of Base Material to SAMMS Materials

In a typical procedure for preparing and characterizing phenyl-coated SAMMS (Ph-SAMMS) material and for attaching organosilanes to silica substrates in general, phenyltrimethoxysilane is attached to MCM-41. Other alkoxy and/or halo-silanes also are suitable, e.g., phenyltriethoxysilane, trichlorophenylsilane. Silanes comprising other aromatic moieties (e.g., naphthalene) also can be used.

5 g MCM-41 and 100 mL toluene are added to a 250 mL round bottom flask. The mixture is stirred for 10 minutes, and a small amount of deionized water is added (calculated based on amount of organosilane to be added). Typically, the water:organosilane ratio is 2.5:1 (on a mole:mole basis). The solution is stirred at room temperature for at least one hour.

An organosilane is added to the mixture and heated to reflux with stirring. The amount of the organosilane depends on the molecular weight of the organosilane, the surface area of the substrate, and the desired coverage. The solution is refluxed for 1.5 to 2 hours. Methanol or ethanol byproduct is distilled until the azeotropic temperature is reached. The solution is refluxed for another 8-10 hours. The solution is distilled again to the azeotrope. The solution is refluxed for an additional 2 hours.

Without cooling, the solution is filtered through a sintered glass funnel to remove unreacted organosilane and unwanted byproducts. Once the material is reasonably cool (e.g., no longer hot enough to boil methanol), it is washed 3 times with 100 mL methanol. The washed material is dried in a vacuum oven at 40 C for at least 4 hours.

### Attachment of Active Materials to Base Material/SAMMS

The active material compound is dissolved in about 4 mL dichloromethane. Other solvents such as chloroform or tetrahydrofuran also work as long as they evaporate quickly, dissolve the active material compounds, and can permeate the support, e.g., MCM-41. The base material-coated SAMMS, e.g., phenyl-SAMMS, is added to the dissolved active material compound. The container is capped to prevent evaporation, and shaken for at least 8 hours on a gentle shaking table at 1 Hz. After shaking, the solution is opened, placed in a fume hood, and allowed to evaporate. The materials are then washed with methanol. Typically, the material is placed in a sintered funnel. Methanol is added and swirled for 30 seconds, and then filtered. The wash procedure is repeated. Washes are designed to remove loosely attached active material without substantially removing bound active material. The volume used to wash depends on the mass of material being used, and typically, 2 mL is suitable for 200-300 mg of material.

### Thermogravimetric Analysis

Thermogravimetric analysis (TGA) can be used to calculate the density of the base material and active material on the substrate. TGA typically is performed under inert atmosphere (N₂) but clean air streams can be used. Typically about 6 mg of material is used for analysis, but the amount may vary depending on the instrument model. In a typical TGA analysis program, the sorbent material is equilibrated at 25° C. and then heated at a rate of about 5 degrees a minute to 105° C. The heated sorbent material is held at 105° C. for 45 minutes to remove water. The sorbent materials is then heated at a rate of about 3 degrees a minute to 350° C., followed by heating at a rate of about 5 degrees a minute to 800° C. The sorbent material is then held at 800° C. for 30 minutes.

To determine base material density on Ph-SAMMS materials, mass loss is measured from a temperature of 360° C. to 800° C. Mass lost in this temperature region can be attributed to removal of a carbon portion of the material. The density of an active material can be estimated if similar TGA data is also available for the Ph-SAMMS material that was used to make the SH-functionalized material. The difference in mass loss between the two is attributed to the active material. Because the active material burns off simultaneously with the base (phenyl) material, this technique can result in a calculated density that has up to a 15% margin of error.

### Ellman's Test

Ellman's test is a colorimetric test in which an indicator reagent (Ellman's reagent, i.e., 5,5′-dithiobis-(2-nitrobenzoic acid) or DTNB) binds to thiols and provides a colorimetric response. Ellman's test is specific for thiol-bearing materials and was used in two different ways herein: 1) to determine the density of the active material and 2) to determine the extent of leaching of this material when the material is placed in an aqueous environment. Ellman's test is typically more accurate than TGA for determining active material density.

A typical Ellman's procedure for testing thiol density follows. A working solution of Ellman's reagent typically is prepared by dissolving 25 mg of Ellman's reagent in 6 mL of phosphate buffer. However, deionized water or any other aqueous matrix of interest may be used in place of the buffer. The SH-bearing material is ground into a fine powder and wetted with a small amount of methanol (50 μL is enough for a 10 mg sample of MCM-41 material). An aqueous matrix is added. This matrix is usually a 0.1 M phosphate buffer at pH 8.0, although carbonate and Tris buffers from pH 6 to 9 also are suitable. The amount of aqueous matrix used is selected to thoroughly suspend the material while maintaining sufficient reagent concentrations to obtain a measurable absorbance value. Typically 3-6 mL is used with 10-50 mg of SH-bearing material. Ellman's reagent (100 to 200 μL of the working solution) is added, and the mixture is shaken gently for 10-15 minutes. The solid is removed by filtering the solution through a 0.2 micron syringe filter. The absorbance of the filtrate at 412 nm is measured. The data from this experiment is usually represented as mmols active material molecule per gram material.

A typical Ellman's procedure for testing leaching into an aqueous matrix follows. The SH-bearing material is wetted, and the matrix is added as in the previous procedure. The material is shaken at 1 Hz for several hours (e.g., 2 hours). The solution is filtered through a 0.2 micron syringe filter to remove solid materials. Ellman's working solution (100 μL) is added to the filtrate. The absorbance at 412 nm is measured. The data from this experiment can be combined with the active material density data and presented as the percent active material leached.

### Example 1

### 1,3- and 1,4-Bis(mercaptomethyl)benzene Phenyl-SAMMS

Phenyl-SAMMS substrates were prepared by the base material method described above. MCM-41 was hydrated with a toluene/water mixture, followed by addition of trichlorophenylsilane and stirring overnight at room temperature. Phenyl coverage was determined by gravimetric analysis, taking the change in mass and dividing by the total surface area to give an average distribution of ligand which ranged from 0.01 molecules nm⁻² (sparsely covered surface) to 3.1 molecules nm⁻². Either 1,3- or 1,4-bis-(mercaptomethyl)benzene was then attached to the phenyl-SAMMS by the active material procedure outlined above.

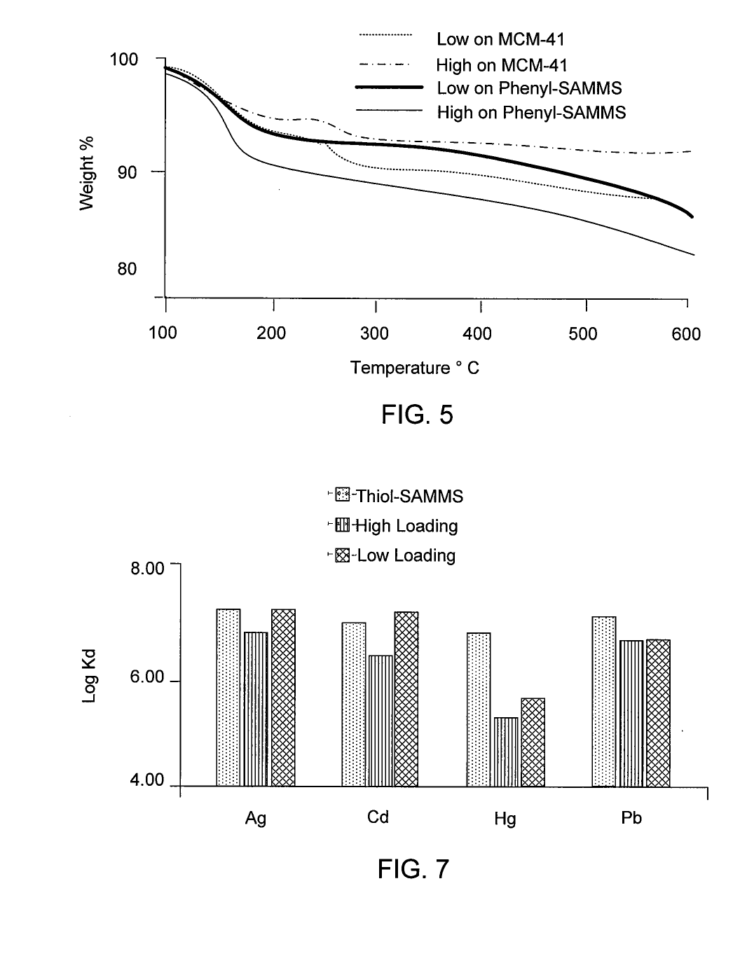

A sorbent material of 1,4-BMMB physisorbed onto native MCM-41 was compared to a phenyl-modified support (phenyl-SAMMS material) containing 1,4-BMMB at two different ligand loading levels. The two materials had a significantly different burn-off rate by thermogravimetric analysis (TGA 2950, TA Instruments, New Castle, DE). As shown in FIG. 5, the physisorbed 1,4-BMMB demonstrated a relatively rapid weight loss starting around 235° C. and ending near 255° C. (dashed lines; upper dashed line represents a low level of ligand binding and lower dashed line represents a high level of ligand binding). In comparison, 1,4-BMMB ligand desorption from the phenyl monolayer-stabilized silica occurred at a slightly elevated temperature compared to the physisorbed ligand and continued from roughly 200° C. to around 350° C. (solid lines; upper solid line represents a low level of ligand binding and lower solid line represents a high level of ligand binding) as verified by the continued detection of SO⁺ (47.9 m/z) and SO₂⁺ (63.8 m/z) by mass spectrometry (Thermo Star, Balzers Instruments, Liechtenstein). The loss of the phenyl monolayer was observed above 350° C. and continued to 600° C., and also was monitored by electron impact mass spectrometry (EI-MS) with ions detected at 49.9, 50.8, 51.8, and 78.2 m/z, corresponding to C₆H₆⁺ fragmentation typical of this type of mass analyzer.

The extended burn-off range of 1,4-BMMB from the phenyl-SAMMS is thought to be due to an increase in stabilization of the arylthiol ligands provided by the weak, reversible interactions between phenyl monolayer and adsorbed ligand. Benzylmercaptan (BM) was also found to be stabilized by the phenyl monolayer as indicated by TGA.

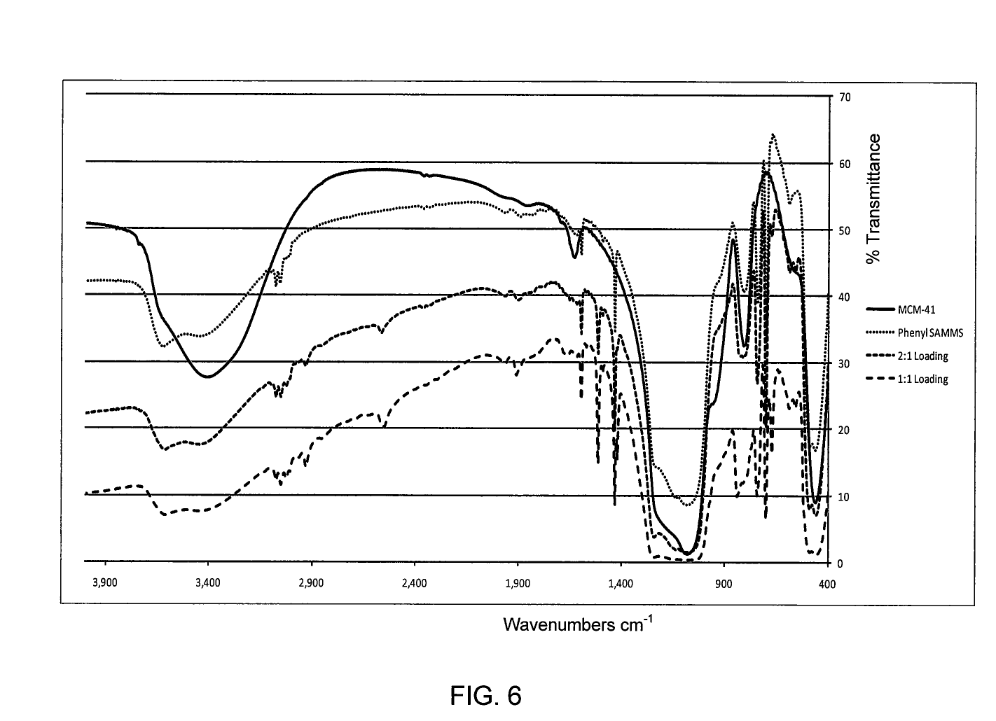

FTIR was used to examine the surface makeup by comparing relative intensities of prominent peaks between samples. The thiol S—H and C—S stretching frequencies, 2545 and 669 cm⁻¹, respectively, were normalized to the aryl C—H stretching frequencies (2926 and 698 cm⁻¹) and C═C stretching frequencies (1595, 1512, and 1432 cm⁻¹) to verify loading of both monolayer and adsorbed ligand. The spectra of bare MCM-41, phenyl-SAMMS, and 1,4-BMMB loaded at 2:1 (i.e., 2 phenyl molecules to 1 molecule 1,4-BMMB) and 1:1 ratios are shown in FIG. 6. 1,4-BMMB sorbent material with bound Pb²⁺ or Hg²⁺ lacked any S—H stretching, as expected.

In addition, powder X-ray diffraction (XRD revealed a dominant (100) peak at 2.11 degrees but lacked higher angle peaks for all substrates. It has been reported that a decrease in peak intensity is directly related to the extent of modification of the pore with organics. A similar decrease in the (100) peak intensity consistent with the chemisorptions of 1,4-BMMB onto phenyl-SAMMS was observed.

A plot of log K_{d} values for phenyl-SAMMS (see FIG. 7) loaded at 3.1 phenyl molecules nm⁻² containing 1,4-BMMB loaded at either 2:1 (i.e., 2 phenyl molecules to 1 molecule 1,4-BMMB, “low loading”) or 1:1 (“high loading”) showed similar capture levels with the covalently attached thiol-SAMMS in a Hanford well water matrix spiked with 500 ppb Hg²⁺, Pb²⁺, Cd²⁺, and Ag⁺ ions. Greater Kd values indicate a greater affinity of the sorbent material for the target species.

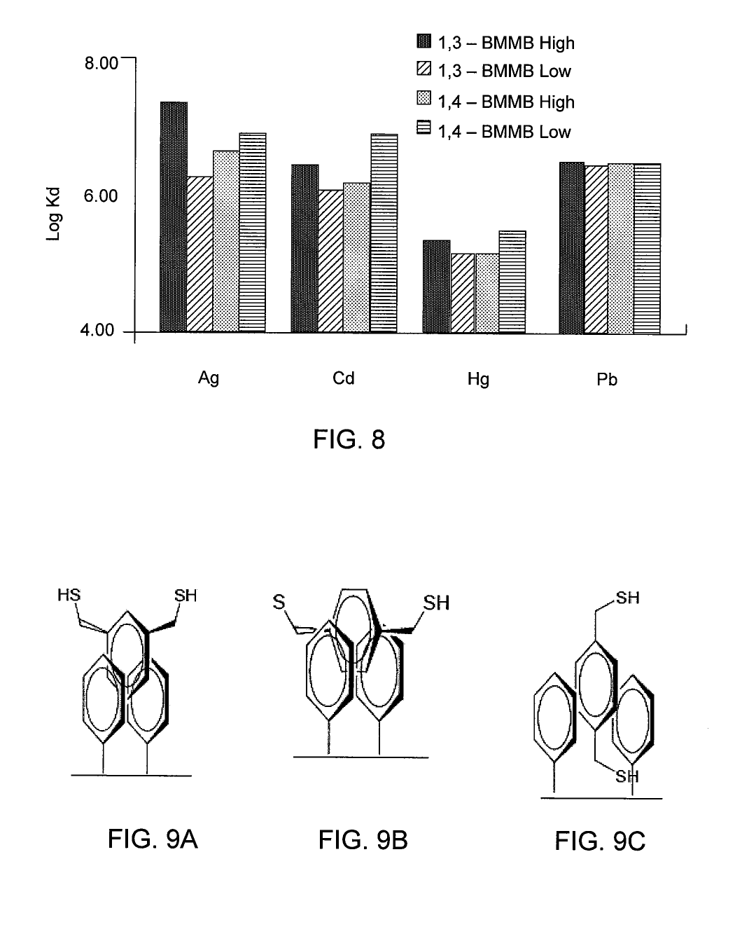

Both 1,3- and 1,4-BMMB exhibited similar uptake levels at near equivalent loadings as shown in FIG. 8. This result is somewhat surprising as the assumed herringbone arrangement between the phenyl monolayer and the functionalized ligands would result in at least one thiol group of 1,4-BMMB being buried in the monolayer to maximize edge-to-edge contacts as shown in FIG. 9C. This appears not to be the case due to the similar uptake levels between 1,3- and 1,4-BMMB with lower levels for BM containing only one reactive thiol under similar loadings. It is possible that the BMMB ligands are only partially intercalated into the phenyl monolayer in an offset stacking resulting in sufficient accessibility by the metal ions to the bulk of the thiol head groups as shown in FIGS. 9A and 9B, or that the covalently attached phenyl monolayer is arranged in a disordered herringbone configuration which can accommodate further π-stacking from arylthiol ligands.

As 1,4-BMMB loading increased, uptake decreased for Hg²⁺, Cd²⁺, and Ag⁺ ions, but not Pb²⁺ ions. This decrease may be due to the thiol sites becoming buried in the monolayer as loading densities increase, forcing rearrangement of the rings to maximize contacts. Densely packed thiol head groups (L) of thiol-SAMMS material are shared by the same metal ion resulting in MLₙ species where n>1. This maximization of metal-thiol contacts may manipulate the weakly bound ligands to adopt a more ideal geometry for binding at the various loadings investigated.

The metal affinity levels of the BMMB-phenyl-SAMMS are nearly equal to that of covalently bound thiol-SAMMS, which have been shown to have affinity levels for heavy metal ions that are one to three orders of magnitude greater than commercially available thiol-based resins such as Amberlite® GT-73 (Supelco) resin.

The effects of density of the covalently bound phenyl material were investigated by varying the loading from 0.01 phenyl molecules nm⁻² to 3.1 molecules nm⁻² while maintaining 1,3- and 1,4-BMMB loading levels equal to previous tests. Surprisingly, the sparsely populated phenyl-SAMMS with BMMB performed substantially the same as that of material with high phenyl monolayer density. Without wishing to be bound to any particular theory, the bound phenyl ring of the monolayer appears to be capable of acting as a nucleation site resulting in BMMB anchoring to the surface in a stacked or offset manner to provide a surface rich in chelation sites capable of metal ion uptake.

### Example 2

### Comparison of Active Material Molecules

Several active material molecules were bound to phenyl-SAMMS by the active material procedure described above. The molecules included benzylmercaptan, 2-mercaptomethyl naphthalene, 1,4-bis(mercaptomethyl)benzene, and 1,4-bis(mercapto-methyl)tetrafluorobenzene. Ellman's Test was used to determine the loading (amount of active material successfully attached to the phenyl-SAMMS surface) and the percent of the active material that leached into water after 2 hours. Surface coverage on the phenyl-SAMMS was 1.16 molecules nm⁻². Each sample was loaded to about 85% capacity with active material molecules.

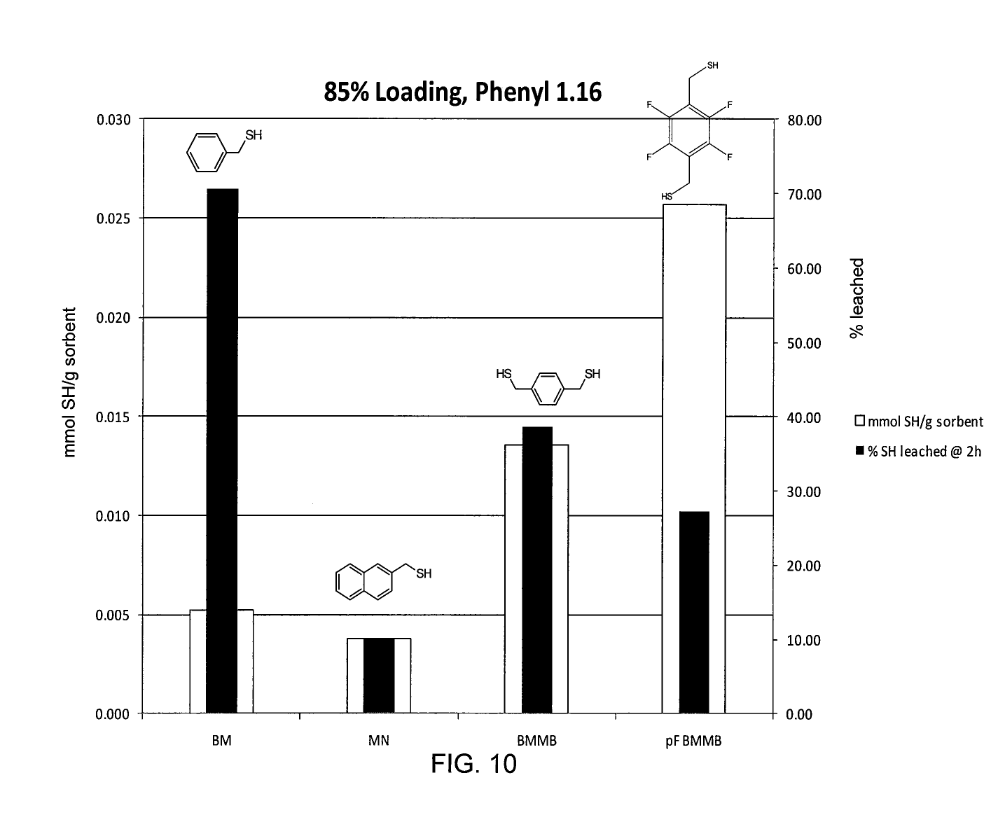

Results are shown in FIG. 10, with the white bars (left axis) representing mmol thiol/g sorbent material and the black bars (right axis) representing percent thiol leached after 2 hours in water. The compound exhibiting the lowest leaching was 2-mercaptomethyl naphthalene with about 10% leaching after 2 hours.

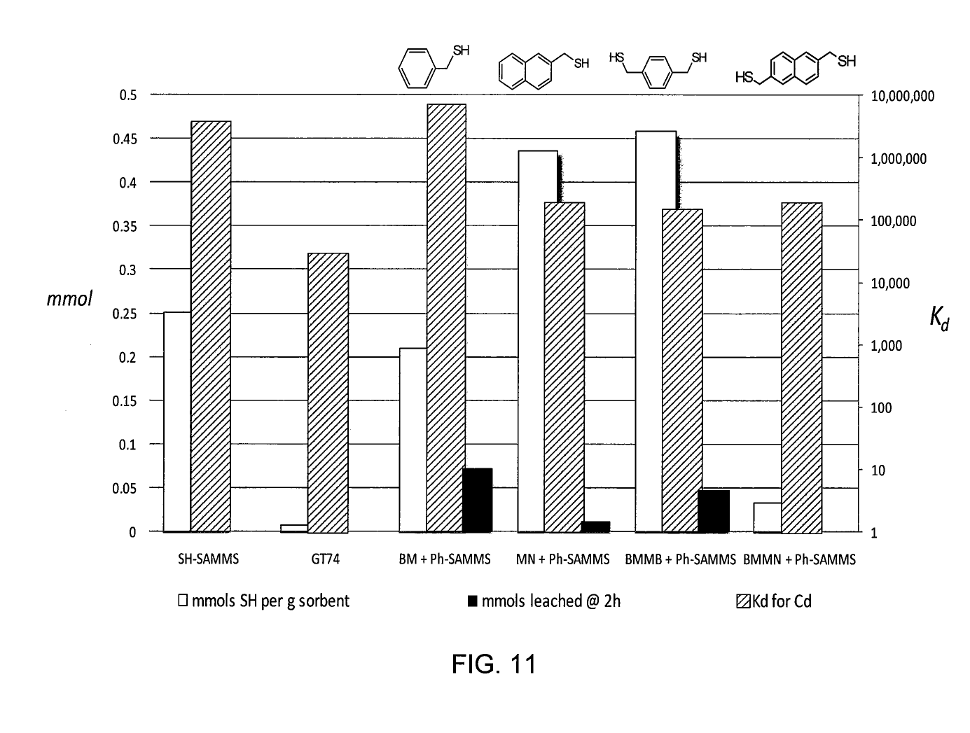

Phenyl-SAMMS with various active materials (benzylmercaptan, 2-mercaptomethyl naphthalene, 1,4-bis(mercaptomethyl)-benzene, and 2,6-bis(mercaptomethyl)naphthalene) were evaluated to determine their binding affinity for Cd²⁺. For comparison, thiol-SAMMS (SAMMS functionalized with 3-mercaptopropylsilane) and commercially available GT74 (a weakly acidic cation exchange resin containing thiol active groups, available from Rohm Haas) also were evaluated. FIG. 11 is a bar graph showing the loading, leaching, and affinity for Cd²⁺. Loading and leaching were measured in terms of mmols —SH per gram of sorbent or mmoles leached after 2 hours in water, respectively. Affinity was evaluated by determining K_{d}.

No leaching was seen with the thiol-SAMMS or GT74 because the active groups are covalently bound to the substrates. The functionalized phenyl-SAMMS materials exhibited 0-30% leaching. K_{d} values for the functionalized phenyl-SAMMS materials ranged from more than 100,000 to nearly 10,000,000. The K_{d} values were an order of magnitude higher than with GT74, and were comparable to thiol-SAMMS.

### Example 3

### Binding Affinity of Thiol-Functionalized SAMMS

Several sorbent materials (Table 2) were evaluated to determine how well they removed various metal cations from solution. All metals had an initial concentration of 50 ppb in filtered river water at a pH=7.6. All materials had an L/S (liquid/solid) ratio of 5,000 mL/g.

To determine a sorbent's affinity for a particular element, the distribution coefficient K_{d} was calculated. K_{d} is measured as follows: A solution containing a known concentration (Cₒ) of an analyte was prepared. The sorbent was added to the solution and agitated gently for 2 hours). The sorbent was removed by filtering the solution through a 2-micron syringe filter, and the analyte concentration (C_{f}) remaining in solution was measured via ICP-MS (Model 7500ce, Agilent Technologies, Santa Clara, Calif.). Results are shown below in Table 2.

TABLE 2
Representative Distribution Coefficients

| Sorbent | Co | As | Se | Ag | Cd | Hg | Tl | Pb |
|---|---|---|---|---|---|---|---|---|
| GT-74 (commercial thiol resin) | 3,800 | 1,300 | 3,300 | 26,000 | 8,100 | 6,700 | 21,000 | 9,800 |
| SH-SAMMS | 2,300 | 440 | 280 | 3,500,000 | 8,300,000 | 48,000 | 10,000 | 6,400,000 |
| Ph-SAMMS + BM¹ | 2,100 | 1,700 | 3,600 | 6,800,000 | 7,000,000 | 390,000 | 2,500 | 590,000 |
| Ph-SAMMS + BMMB² | 29,000 | 480 | 4,800 | 410,000 | 110,000 | 160,000 | 180,000 | 93,000 |
| Ph-SAMMS + MN³ | 4,600 | 560 | 2,400 | 18,000 | 140,000 | 130,000 | 2,000 | 160,000 |
| Ph-SAMMS + BMMN⁴ | 1,800 | 580 | 1,000 | 180,000 | 690,000 | 140,000 | 2,100 | 460,000 |
| Ph-SAMMS “inactive layer” | 390 | 560 | 1,000 | 5,000 | 1,800 | 19,000 | 1,200 | 220,000 |
| MCM-41 (mesoporous silica) | 1,400 | 1,200 | 370 | 9,900 | 3,200 | 12,000 | 1,100 | 58,000 |
| MCM 41 + BMMB | 25,000 | 1,100 | 20,000 | 24,000 | 20,000 | 19,000 | 12,000 | 18,000 |

All metals 50 ppb in filtered river water, pH 7.6, all materials L/S of 5,000

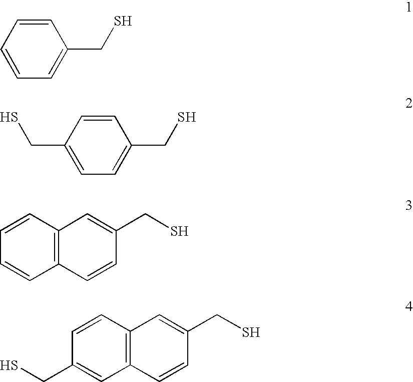

As seen in Table 2, evaluated embodiments of the renewable sorbent materials had much greater affinity for metal cations than the bare mesoporous silica or the commercial GT74 resin. The affinities were comparable to covalently bound SH-SAMMS material, with the exception of lead. While SH-SAMMS also demonstrated high affinity for the evaluated metal cations, its active material is covalently bound. Thus, SH-SAMMS material lacks the advantages of the Ph-SAMMS materials, i.e., the ability to easily remove the thiol ligand and its bound metal cations and then regenerate the sorbent material with a new active material.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A material, comprising:
a support;
a base material comprising a first compound secured to the support; and
an active material reversibly bound to the base material, wherein the active material comprises a second compound having at least one functional group R configured to bind to at least one predetermined target species.

2. The material of claim 1, wherein the support is a mesoporous support.

3. The material of claim 2, wherein the mesoporous support is a silica-based material.

4. The material of claim 3, wherein the first compound is an aromatic compound.

5. The material of claim 4, wherein the aromatic compound is an organosilane comprising a phenyl, nitrophenyl, thiophene, pentafluorophenyl, or hydroxypyridinoate group.

6. The material of claim 1, wherein the target species are metals, metalloids, oxyanions, radioactive species, polar organic compounds, and combinations thereof.

7. The material of claim 6, wherein the functional group R is hydroxyl, thiol, carboxyl, ketone, thione, aldehyde, amide, amine, carbamide, sulfonamide, imide, imine, phosphine, or phosphine oxide.

8. The material of claim 6, wherein the functional group R is —SH, —N(CH₂CO₂H)₂, —OH, —NHCONH₂, —NHCSNH₂, SO₂NH₂, or —NHCOCH₂P(═O)R′R″) wherein R′ and R″ are independently lower alkyl or aryl groups.

9. The material of claim 6, wherein the first compound is an aromatic compound and the active material comprises 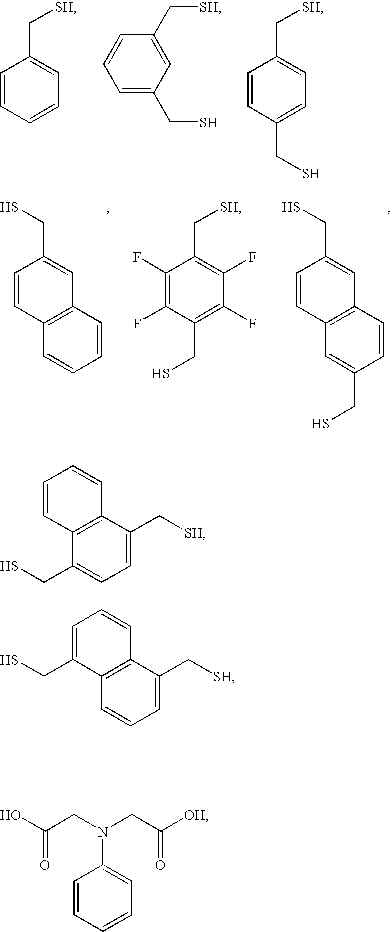
or a combination thereof.

10. The material of claim 6, wherein the at least one target species is a metal cation selected from arsenic, selenium, cobalt, silver, cadmium, mercury, thallium or lead, and the sorbent material has a distribution coefficient of at least 1×10⁴ for the target species.

11. The material of claim 1, where the support is a nanoparticle.

12. The material of claim 1, where the first compound is an aromatic compound and the second compound is an aromatic compound.

13. The material of claim 12, wherein the second compound comprises:
an aromatic ring;
at least one linker Y covalently attached to the aromatic ring; and
at least one functional group R covalently attached to the at least one linker Y.

14. The material of claim 13, wherein the at least one linker Y is a methyl or ethyl group.

15. A method, comprising:
binding a base material comprising a first compound to a support; and
reversibly binding an active material comprising a second compound to the base material, wherein the second compound comprises at least one functional group.

16. The method of claim 15, wherein the support is a silica-based mesoporous support.

17. The method of claim 15, wherein the first compound is an aromatic organosilane.

18. The method of claim 17, wherein the second compound is an aromatic compound comprising the at least one functional group.

19. The method of claim 18, wherein reversibly binding comprises exposing the active material to the base material such that π electrons on an aromatic ring of the active material interact with π electrons on an aromatic ring of the base material.

20. The method of claim 15, wherein reversibly binding comprises combining a dissolved active material with a base material such that the active material associates with the base material via electrostatic interactions.

21. A method, comprising:
exposing a solution comprising an initial concentration of a target species to a material comprising a support, a base material comprising a first compound covalently bound to the support, and an active material comprising one or more second compounds reversibly bound to the base material, the second compound comprising at least one functional group capable of binding at least a portion of the target species to the functional group, wherein at least a portion of the target species binds to the active material when the solution is exposed to the material, thereby producing bound target species; and
delivering a stripped solution based on the exposed solution.

22. The method of claim 21, wherein the active material has a greater solubility in the base material than in the solution.

23. The method of claim 21, wherein less than 10% of the second compound dissociates from the base material when the sorbent material is exposed to the solution.

24. The method of claim 21, wherein the active material comprises a plurality of second compounds and at least a portion of a plurality of target species binds to the active material when the solution is exposed to the material, thereby producing a plurality of bound target species.

25. The method of claim 21, further comprising
removing at least a portion of the active material and bound target species from the base material and support after the exposure.

26. The method of claim 25, wherein at least 50% of the active material is removed after the exposure.

27. The method of claim 25, wherein removing the active material comprises rinsing with a solvent in which the active material is soluble.

28. The method of claim 27, wherein the active material has a greater solubility in the solvent than in the base material.

29. The method of claim 25, wherein the active material is an aromatic material and the removing is performed by exposure to a nonpolar solvent.

30. The method of claim 25, further comprising reversibly binding a second active material to the base material and support to regenerate the material.

31. The method of claim 25, further comprising separating the active material and bound target species.

32. The method of claim 31, further comprising reversibly binding the separated active material to the base material and support to regenerate the material.
